(19) United States
(12) Patent Application Publication
(10) Pub. No.: US 2006/0107218 A1
(43) Pub. Date: May 18, 2006

(54) View-based navigation model for graphical user interfaces

(75) Inventors: Bradford R. Clark, Duvall, WA (US); Vanessa Cristina Feliberti, Sammamish, WA (US)

Correspondence Address: SENNIGER POWERS, ONE METROPOLITAN SQUARE, 16TH FLOOR, ST. LOUIS, MO, 63102, US

(73) Assignee: Microsoft Corporation, Redmond, WA (US)

(21) Appl. No.: 11/333,168

(22) Filed: Jan. 17, 2006

(51) Int. Cl. G06F 17/00; G06F 9/00; G06F 3/00

(52) U.S. Cl. 715/733; 715/853; 715/764

(57) ABSTRACT

A graphical user interface for grouping a collection of objects having related categories or actions in a common product-neutral container of a navigation tree. The grouping permits a user to easily locate related objects from plurality of computer system or network product hierarchical trees in a single container.

### BACKGROUND

Graphical user interfaces are utilized to navigate complex hierarchies of data items. Large or complex computer systems or networks often comprise many related items associated with different servers or in different data hierarchies. Moreover, related items may be associated with different products. Often, related items may need to be changed on a network regardless of the item's server or associated product. For related items to be changed, an administrator or authorized end user first must find the item on the product or server hierarchical tree where it is located in order to make change the item. For example, a computer network may contain many user objects associated with several different products such as email, various databases, software products, and the like, yet representing the same user. For a user to be changed, such as deleting the user when they are no longer employed by a company, the administrator must locate the user on each of the product hierarchical trees and perform the required operation. This can be a tedious process for complicated systems containing numerous and/or complex hierarchical trees because multiple trees must be traversed to reach the end node associated with the user.

The problems of existing graphical user interfaces for traversing multiple hierarchical trees becomes even more pronounced when a network or system contains many servers and products. The problem of changing configuration or data in a large system or network is exacerbated when data and applications residing on a computer system or network change on a regular basis. Thus, the physical hierarchy of a data structure of a computer system or network can dramatically change over a short period of time, requiring time-consuming traversal of hierarchical trees in order to make even simple changes to data objects that are specific to different computer products or operations.

In existing graphical user interfaces it is common to split the viewable work area of the user display screen into multiple panes. The left pane is usually used for object navigation. It follows a conventional containment model. The right pane reflects the child hierarchy of the selected item in the navigation pane. One significant problem with this model is that the contents of the navigation pane are organized with a “product” as the top-level qualifier and then further segmented based on product-specific objects, which reflect the data structure layout.

Administrators and authorized end users, however, often do not conceptualize the tasks they must perform in terms of products and objects, and the tasks are performed most often not because of a product but because of some kind of event that has occurred. To react to that event, or perform that task, administrators often must access multiple products, each with its own hierarchical tree and object model. The net result of this is that seemingly simple tasks, such as adding and authorizing a user of multiple products, may take a protracted period of time switching between products, and require significant knowledge of each product's hierarchical tree, to reach the leaf nodes in which they perform the necessary action.

### SUMMARY

One or more deficiencies of the known art are overcome by methods of generic grouping of objects on a navigation tree that are utilized across different products or applications. A top-level navigation pane provides categorizations of top-level containers comprising a navigation tree of selectable objects. These categories are product or application-independent (hereinafter collectively referred to as “product-independent”) and are applicable to all enterprise computer systems. The selectable objects on the navigation tree contained in the top-level container are based upon the categories of the objects that are associated with a plurality of products or functions that can be executed on a computer system or network.

In another aspect, computer-readable media are provided having a data structure stored thereon. The data structure comprises a plurality of objects on the navigation tree of a related category or action contained in a first field of data, wherein the objects are located on a plurality of different product hierarchical trees of data.

Computer-readable media having computer-executable instructions for displaying objects in a hierarchy and for navigating a hierarchy embody further aspects of the invention.

Alternatively, the invention may comprise various other methods and apparatuses.

Other features will be in part apparent and in part pointed out hereinafter.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is an illustration of an exemplary embodiment of a product-neutral navigation tree of the present invention.

FIG. 2 is an exemplary flow diagram illustrating a method of displaying a view-based navigation model according to an embodiment of the invention.

FIG. 3 is a block diagram illustrating one example of a suitable computing system environment in which the invention may be implemented.

FIG. 4 an illustration of a prior graphical user interface wherein user objects are deeply embedded in a product hierarchical tree.

FIG. 5 an illustration of a prior graphical user interface wherein server objects are deeply embedded in a product hierarchical tree.

FIG. 6 an illustration of a prior graphical user interface wherein user objects are contained in a separate tree specific to a single product.

FIG. 7 illustrates one exemplary embodiment of the present invention wherein objects are grouped in a product neutral navigation tree.

FIG. 8 is an illustration of one exemplary embodiment of the present invention wherein multiple detail panes are utilized to simplify the traversal of the navigation tree.

Corresponding reference characters indicate corresponding parts throughout the drawings.

### DETAILED DESCRIPTION

For purposes of the following description, items contained in a navigation or hierarchical tree can be either containers or objects. Containers are items that contain either objects or other containers. In one common example, a container is a folder that can contain other folders or objects. Objects are an end point item of a tree, such as a file of executable code, a database file, a driver, and the like that can not be further traversed to other containers or objects. As used herein, a “hierarchical tree” refers to a tree of containers and objects, such as those corresponding to a specific product. Conversely, a “navigation tree” refers to the tree comprising containers and objects wherein the objects are grouped together in a product-neutral manner, based on a related category or action of the objects.

In one embodiment, a navigation tree comprises a top-level container that contains a navigation tree of objects based upon common categories or related actions of the objects that are common across server types or products. The top-level container can comprise objects or a navigation tree of sub-containers and objects. The objects are grouped together based on common characteristics of the objects rather than the product or server they are associated with. Thus, the objects are grouped together in a product-neutral navigation tree. This allows objects to be categorized in a consistent manner, resulting in co-location of similar objects or action in a common group that can be quickly accessed by an administrator or computer user.

Beneficially, the organizational approach embodying aspects of the present invention can result in a consistent user experience across products, even in the most dynamic of systems or networks. Embodiments of the present invention requires less product-specific knowledge of an administrator or computer user since common category objects are located in a common top-level container rather than in each product or containment-based hierarchical tree. This permits routine tasks to be performed more efficiently since the objects are co-located in a common top-level container that can be quickly accessed. Additionally beneficial, the objects are located at a fixed location with the navigation hierarchy. This further enhances the administrative efficiencies by providing a constant location for objects.

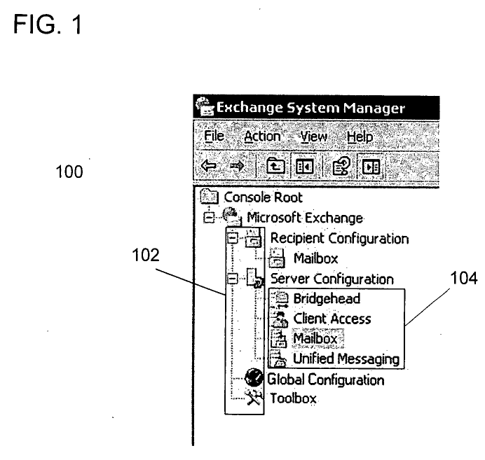

Referring first to FIG. 1, a display screen 100 illustrates exemplary embodiment of a product-neutral navigation tree. Top-level containers 102 are selectable containers at the top level of a navigational tree of selectable items. The top-level containers comprise objects of a related category, wherein the category is associated with a plurality of products or functions. In one example, the top-level containers of the navigational tree are comprised of a plurality of fixed or constant containers related to a specific category. In another embodiment, the top-level containers of the navigational tree are comprised of fixed containers that include objects related to users or recipients; servers; server tools (e.g., “toolbox”); and/or global configuration.

In another example, objects contained in a “Recipient” or “User” top-level container comprise data objects specific to users of different applications throughout a computer network. Thus, while in the past, changes to a user file for a user that utilizes an email application and a database application would require that a network administrator locate and traverse the hierarchical tree for the email application until the file containing user objects is located. The administrator would then locate and traverse a different hierarchical tree for the database application until the user objects are located in order to make the required changes for the user file of the database application. In the configuration of the illustrated embodiment, users of the different applications of a computer server or network are grouped within the common “User” top-level container. Thus, a change to a user file for different applications would require the administrator to only access the user objects contained on the navigation tree in the “User” top-level container, thereby streamlining system-wide changes to user data files.

Objects contained in the “Server Configuration” or “Servers” top-level container are also grouped together according to the type or role of the server. Server objects contained in the “Server Configuration” top-level container can be further grouped on the navigation tree in a lower-level container based upon the function of the server. For example, servers may be grouped in lower-level containers for mailbox servers, database servers, messaging edge servers, DNS servers, and the like that are specific to the servers.

In one embodiment, objects contained in the “Global Configuration” or “Organization Configuration” top-level container are objects that are utilized in implementing global changes in a product. For example, objects that are utilized in establishing global configurations that affect all users (e.g., an organizational policy requiring that all users change their passwords after a set period of time). In another example, an global configuration object would cause the organizational passwords of all contract employees to expire after a contract date is reached.

Objects in the top-level container entitled “Toolbox,” for example, contain server, system, product, or network tool objects that are utilized in systems administration, problem solving, and the like. In this example, objects such as restore data tool, diagnostic tools for server communications, and diagnostic tools for network problems would be contained in the “Toolbox” top-level container.

Top-level container 102 for “Server Configuration” is expanded in the illustrated embodiment of FIG. 1. The expanded top-level container illustrates the further grouping of objects on the navigation tree in lower-level containers 104 according to a common function. In the illustrated embodiment of FIG. 1, the servers are further grouped into lower-level containers 104 entitled “Bridgehead,” “Client Access,” “Mailbox,” and “Unified Messaging.” It is to be understood that these are exemplary labels and the containers 104 are not limited to those illustrated.

In one embodiment, the top-level containers can comprise a plurality of sublevels of containers in which objects having related categories or actions can be grouped.

In another embodiment, an initial set of top-level containers comprises ‘organizations’ (e.g., global, or shared data), ‘users’, ‘servers’, and ‘tools’.

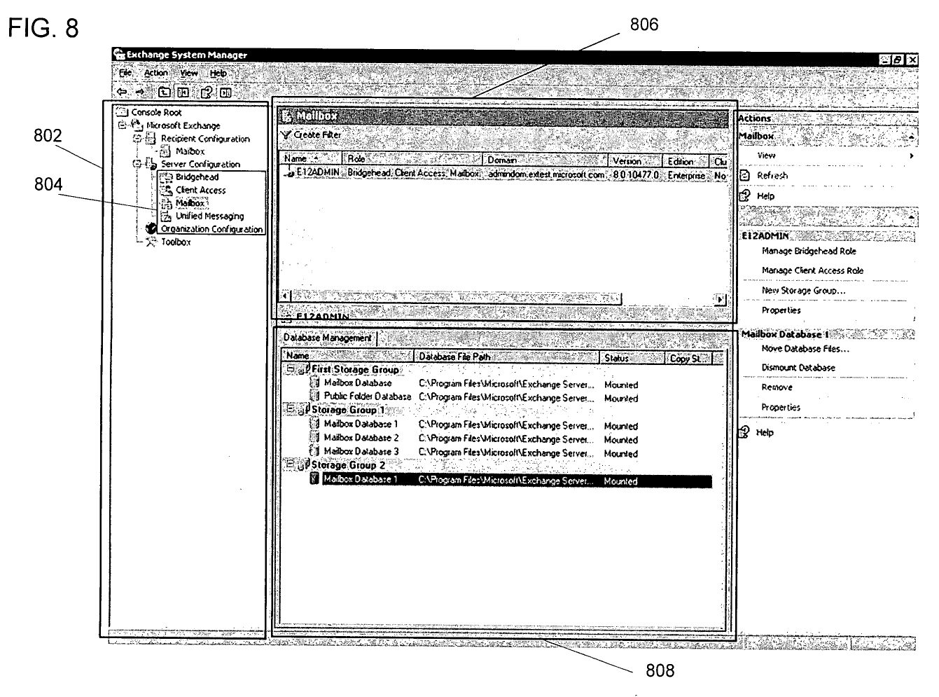

In another embodiment, the selectable objects are displayed in a multiple pane navigation display. In one example, the multiple pane navigation display comprises a top-level pane, a first detail-level pane, and a second detail-level pane. One embodiment of a multiple pane navigation display comprising a top-level pane, a first detail-level pane, and a second detail-level pane is illustrated in FIG. 8.

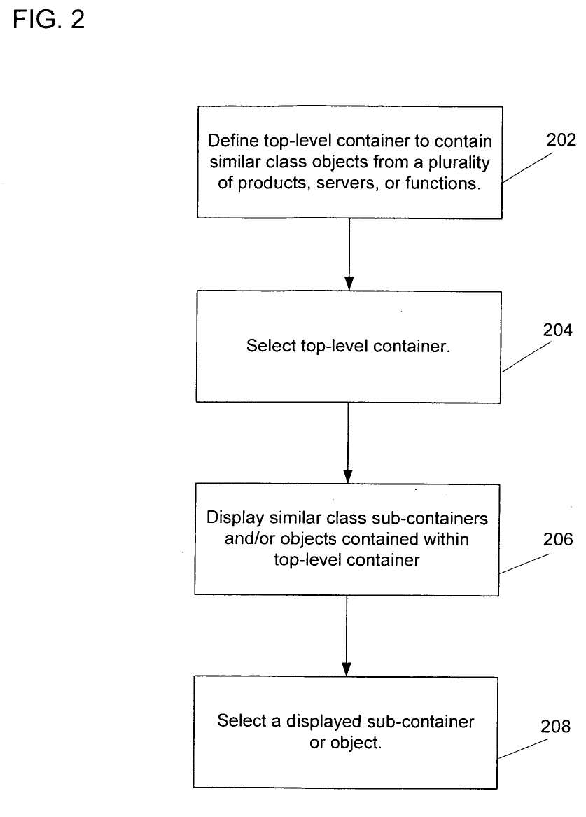

Referring now to FIG. 2, a method is illustrated for displaying a top-level container comprising selectable objects on a navigation tree. At 202 a top-level container is defined to contain similar category objects. The similar category objects being obtained from a plurality of products, servers, or functions. A top-level container is selected at 204. Similar category sub-containers and/or objects on the navigation tree that are contained within the top-level container are displayed at 206. A displayed sub-container or object is selected at 208.

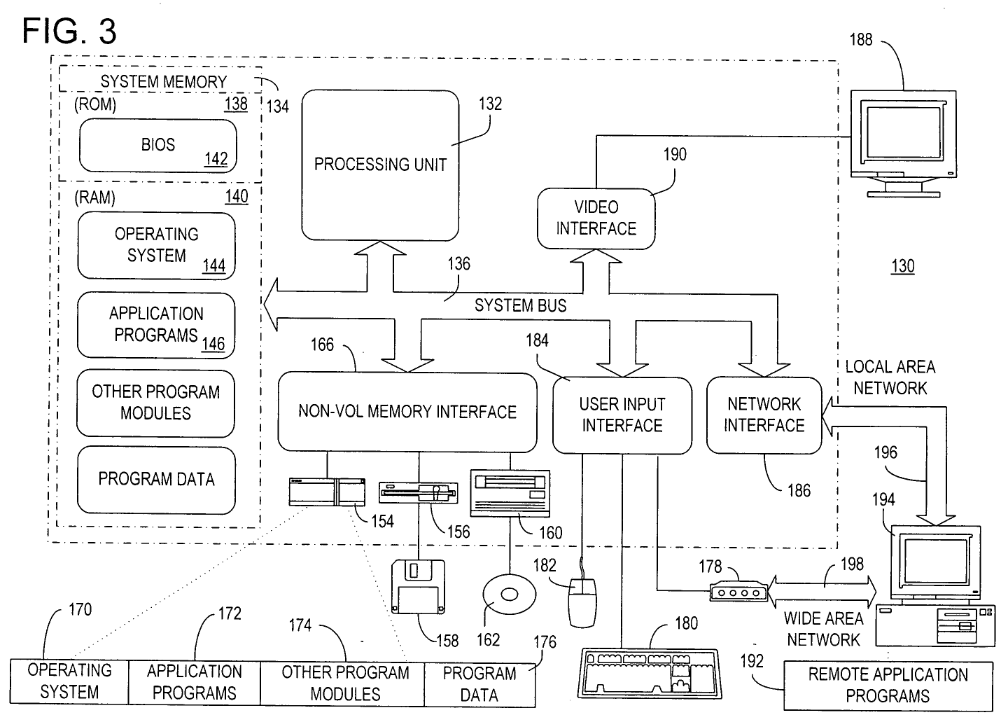

FIG. 3 shows one example of a general purpose computing device in the form of a computer 130. In one embodiment of the invention, a computer such as the computer 130 is suitable for use in the other figures illustrated and described herein. Computer 130 has one or more processors or processing units 132 and a system memory 134. In the illustrated embodiment, a system bus 136 couples various system components including the system memory 134 to the processors 132. The bus 136 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 130 typically has at least some form of computer readable media. Computer readable media, which include both volatile and nonvolatile media, removable and non-removable media, may be any available medium that may be accessed by computer 130. By way of example and not limitation, computer readable media comprise computer storage media and communication media. Computer storage media include volatile and nonvolatile, removable and non-removable media implemented in any method or technology for storage of information such as computer readable instructions, data structures, program modules or other data. For example, computer storage media include RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium that may be used to store the desired information and that may be accessed by computer 130. Communication media typically embody computer readable instructions, data structures, program modules, or other data in a modulated data signal such as a carrier wave or other transport mechanism and include any information delivery media. Those skilled in the art are familiar with the modulated data signal, which has one or more of its characteristics set or changed in such a manner as to encode information in the signal. Wired media, such as a wired network or direct-wired connection, and wireless media, such as acoustic, RF, infrared, and other wireless media, are examples of communication media. Combinations of any of the above are also included within the scope of computer readable media.

The system memory 134 includes computer storage media in the form of removable and/or non-removable, volatile and/or nonvolatile memory. In the illustrated embodiment, system memory 134 includes read only memory (ROM) 138 and random access memory (RAM) 140. A basic input/output system 142 (BIOS), containing the basic routines that help to transfer information between elements within computer 130, such as during start-up, is typically stored in ROM 138. RAM 140 typically contains data and/or program modules that are immediately accessible to and/or presently being operated on by processing unit 132. By way of example, and not limitation, FIG. 3 illustrates operating system 144, application programs 146, other program modules 148, and program data 150.

The computer 130 may also include other removable/non-removable, volatile/nonvolatile computer storage media. For example, FIG. 3 illustrates a hard disk drive 154 that reads from or writes to non-removable, nonvolatile magnetic media. FIG. 3 also shows a magnetic disk drive 156 that reads from or writes to a removable, nonvolatile magnetic disk 158, and an optical disk drive 160 that reads from or writes to a removable, nonvolatile optical disk 162 such as a CD-ROM or other optical media. Other removable/non-removable, volatile/nonvolatile computer storage media that may be used in the exemplary operating environment include, but are not limited to, magnetic tape cassettes, flash memory cards, digital versatile disks, digital video tape, solid state RAM, solid state ROM, and the like. The hard disk drive 154, and magnetic disk drive 156 and optical disk drive 160 are typically connected to the system bus 136 by a non-volatile memory interface, such as interface 166.

The drives or other mass storage devices and their associated computer storage media discussed above and illustrated in FIG. 3, provide storage of computer readable instructions, data structures, program modules and other data for the computer 130. In FIG. 3, for example, hard disk drive 154 is illustrated as storing operating system 170, application programs 172, other program modules 174, and program data 176. Note that these components may either be the same as or different from operating system 144, application programs 146, other program modules 148, and program data 150. Operating system 170, application programs 172, other program modules 174, and program data 176 are given different numbers here to illustrate that, at a minimum, they are different copies.

A user may enter commands and information into computer 130 through input devices or user interface selection devices such as a keyboard 180 and a pointing device 182 (e.g., a mouse, trackball, pen, or touch pad). Other input devices (not shown) may include a microphone, joystick, game pad, satellite dish, scanner, or the like. These and other input devices are connected to processing unit 132 through a user input interface 184 that is coupled to system bus 136, but may be connected by other interface and bus structures, such as a parallel port, game port, or a Universal Serial Bus (USB). A monitor 188 or other type of display device is also connected to system bus 136 via an interface, such as a video interface 190. In addition to the monitor 188, computers often include other peripheral output devices (not shown) such as a printer and speakers, which may be connected through an output peripheral interface (not shown).

The computer 130 may operate in a networked environment using logical connections to one or more remote computers, such as a remote computer 194. The remote computer 194 may be a personal computer, a server, a router, a network PC, a peer device or other common network node, and typically includes many or all of the elements described above relative to computer 130. The logical connections depicted in FIG. 3 include a local area network (LAN) 196 and a wide area network (WAN) 198, but may also include other networks. LAN 136 and/or WAN 138 may be a wired network, a wireless network, a combination thereof, and so on. Such networking environments are commonplace in offices, enterprise-wide computer networks, intranets, and global computer networks (e.g., the Internet).

When used in a local area networking environment, computer 130 is connected to the LAN 196 through a network interface or adapter 186. When used in a wide area networking environment, computer 130 typically includes a modem 178 or other means for establishing communications over the WAN 198, such as the Internet. The modem 178, which may be internal or external, is connected to system bus 136 via the user input interface 184, or other appropriate mechanism. In a networked environment, program modules depicted relative to computer 130, or portions thereof, may be stored in a remote memory storage device (not shown). By way of example, and not limitation, FIG. 3 illustrates remote application programs 192 as residing on the memory device. The network connections shown are exemplary and other means of establishing a communications link between the computers may be used.

Generally, the data processors of computer 130 are programmed by means of instructions stored at different times in the various computer-readable storage media of the computer. Programs and operating systems are typically distributed, for example, on floppy disks or CD-ROMs. From there, they are installed or loaded into the secondary memory of a computer. At execution, they are loaded at least partially into the computer's primary electronic memory. The invention described herein includes these and other various types of computer-readable storage media when such media contain instructions or programs for implementing the steps described below in conjunction with a microprocessor or other data processor. The invention also includes the computer itself when programmed according to the methods and techniques described herein.

For purposes of illustration, programs and other executable program components, such as the operating system, are illustrated herein as discrete blocks. It is recognized, however, that such programs and components reside at various times in different storage components of the computer, and are executed by the data processor(s) of the computer.

Although described in connection with an exemplary computing system environment, including computer 130, the invention is operational with numerous other general purpose or special purpose computing system environments or configurations. The computing system environment is not intended to suggest any limitation as to the scope of use or functionality of the invention. Moreover, the computing system environment should not be interpreted as having any dependency or requirement relating to any one or combination of components illustrated in the exemplary operating environment. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, mobile telephones, network PCs, minicomputers, mainframe computers, distributed computing environments that include any of the above systems or devices, and the like.

The invention may be described in the general context of computer-executable instructions, such as program modules, executed by one or more computers or other devices. Generally, program modules include, but are not limited to, routines, programs, objects, components, and data structures that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

An interface in the context of a software architecture includes a software module, component, code portion, or other sequence of computer-executable instructions. The interface includes, for example, a first module accessing a second module to perform computing tasks on behalf of the first module. The first and second modules include, in one example, application programming interfaces (APIs) such as provided by operating systems, component object model (COM) interfaces (e.g., for peer-to-peer application communication), and extensible markup language metadata interchange format (XMI) interfaces (e.g., for communication between web services).

The interface may be a tightly coupled, synchronous implementation such as in Java 2 Platform Enterprise Edition (J2EE), COM, or distributed COM (DCOM) examples. Alternatively or in addition, the interface may be a loosely coupled, asynchronous implementation such as in a web service (e.g., using the simple object access protocol). In general, the interface includes any combination of the following characteristics: tightly coupled, loosely coupled, synchronous, and asynchronous. Further, the interface may conform to a standard protocol, a proprietary protocol, or any combination of standard and proprietary protocols.

The interfaces described herein may all be part of a single interface or may be implemented as separate interfaces or any combination therein. The interfaces may execute locally or remotely to provide functionality. Further, the interfaces may include additional or less functionality than illustrated or described herein.

The following example further illustrates the invention.

### EXAMPLE 1

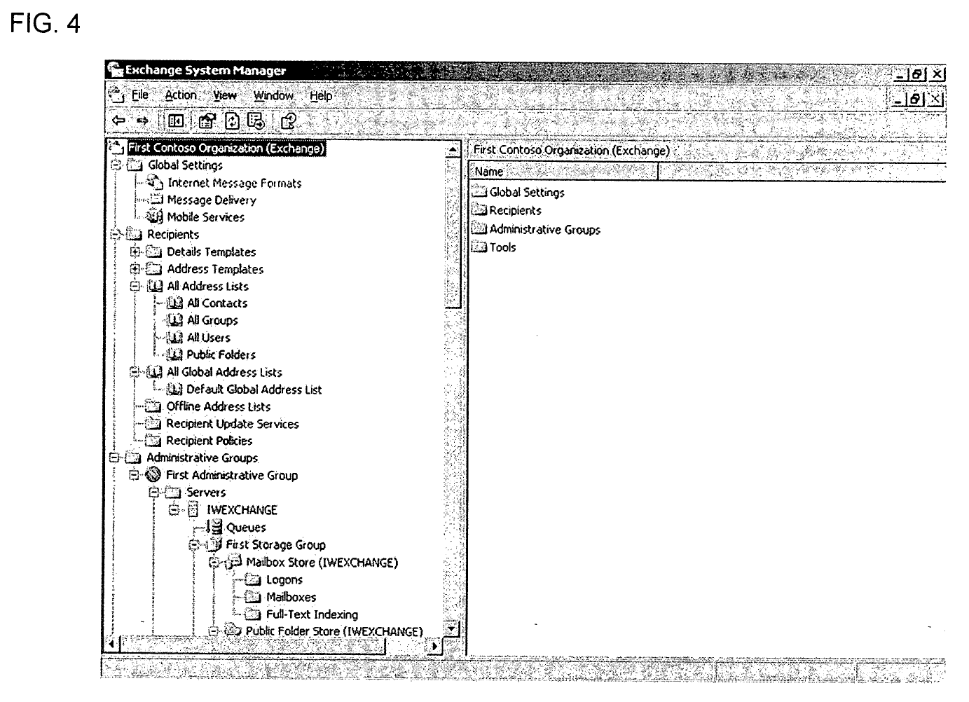

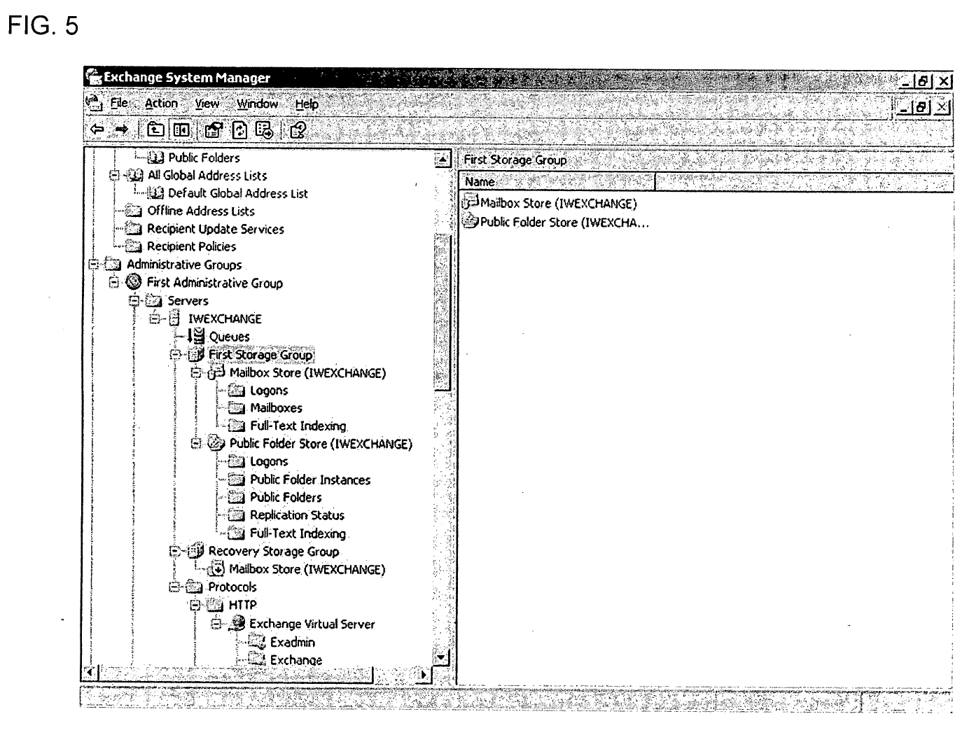

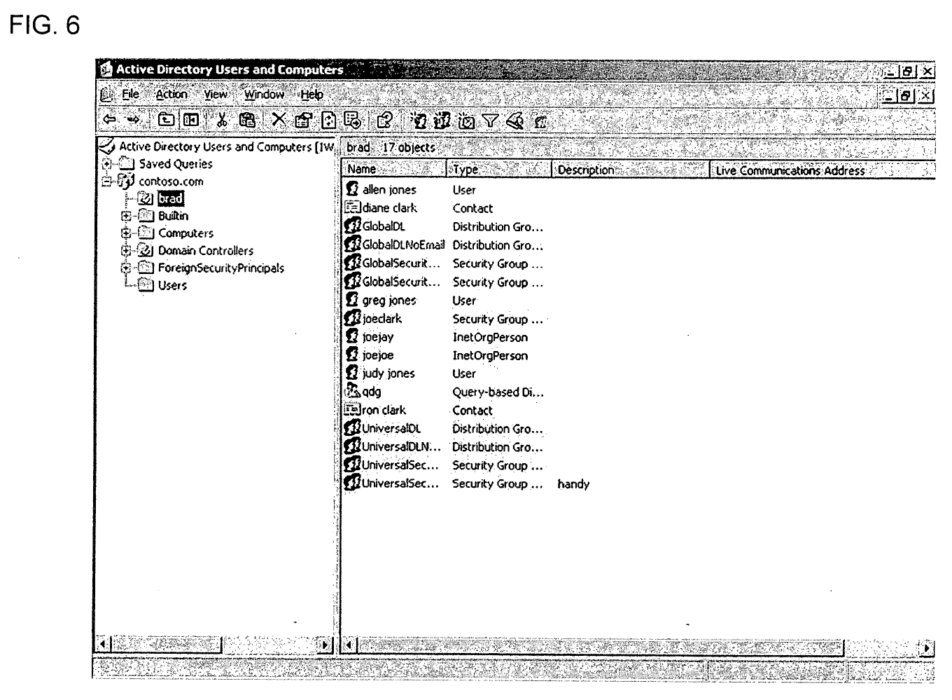

Prior graphical user interfaces have typically located data objects in containment-based hierarchical trees for products or operations which the objects are associated. For common objects that are typically used in multiple products, such as user or server data, modification to the objects can require multiple hierarchical trees to be traversed in order to locate the object for all the products. Furthermore, because the navigation model contains instances of objects, the administrator will never be presented with the same navigational model when viewing different installations of the same product. This can result in inefficiencies and be frustrating for network administrators. An example of such graphical user interfaces is illustrated in FIGS. 4 and 5, wherein user objects (FIG. 4) and server objects (FIG. 5) are deeply embedded in a hierarchical tree for the product “First Contoso Organization.” Thus, an administrator must locate the First Contoso Organization hierarchical tree, traverse the series of parent/child/grandchild containers in the hierarchical tree, and locate the object in order to make changes to the object. This process must be repeated for each product hierarchical tree for which the object, such as a user, is associated. FIG. 6 illustrates a prior graphical user interface wherein user objects are contained in a separate tree specific to a single product. In this illustration, a tree is utilized for managing users that is separate from the First Contoso Organization hierarchical tree of FIG. 4 and FIG. 5, but is still specific to the Contoso product.

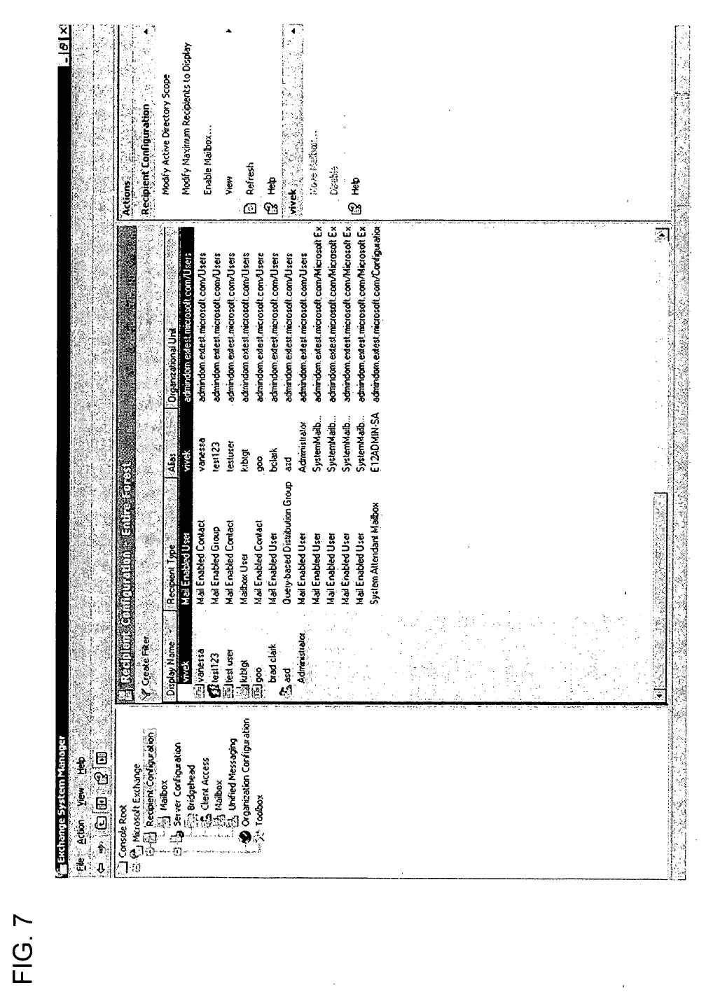

A graphical user interface embodying aspects of the present invention groups related objects together on the basis of the objects' category or function rather than by the product or server with which they are associated. By grouping objects by related category or function rather than by product or server location, objects can be quickly located in a common, fixed navigation tree instead of requiring traversal of multiple product or server hierarchical trees. FIG. 7 illustrates one exemplary embodiment of the present invention wherein objects are grouped in a product neutral navigation tree. FIG. 7 illustrates the grouping of objects within the top-level containers “Recipients,” (e.g., users), “Server Configuration,” for servers, “Organizational Configuration,” for global or shared data, and “Toolbox,” for server, system, product, or network tools that are utilized throughout the computer system or network in systems administration, problem solving, and the like. In FIG. 7 the selection of Recipient Configuration top-level container displays the user objects in a detail pane. The users can be quickly located and modified from one location even though they are associated with one or more products hierarchical trees.

FIG. 8 illustrates one exemplary embodiment of the present invention wherein multiple detail panes are utilized to simplify the traversal of the navigation tree. A top-level pane 802 displays top-level containers that are based upon product-independent categories. In this illustration, sub-container 804 entitled, “Mailbox” within the “Server Configuration” top-level container is selected, opening the contents in first detail-level pane 806. The container located in first detail-level pane 804 is selected, displaying sub-containers entitled, “First Storage Group,” “Storage Group 1,” and “Storage Group 2,” in second detail-level pane 808. Underneath the sub-containers are displayed the objects contained in each sub-container in second detail-level 808. FIG. 8 illustrates the grouping of servers within the “Server Configuration” top-level container by utilizing sub-containers to group the servers by their function, e.g., bridgehead, client access, mailbox, and unified messaging. Further grouping is also illustrated as the navigational tree is traversed until the server object is located.

When introducing elements of the present invention or the embodiment(s) thereof, the articles “a,” “an,” “the,” and “said” are intended to mean that there are one or more of the elements. The terms “comprising,” “including,” and “having” are intended to be inclusive and mean that there may be additional elements other than the listed elements.

In view of the above, it will be seen that the several objects of the invention are achieved and other advantageous results attained.

As various changes could be made in the above constructions and methods without departing from the scope of the invention, it is intended that all matter contained in the above description and shown in the accompanying drawings shall be interpreted as illustrative and not in a limiting sense.

What is claimed is:

1. In a computer system connected to a network, the computer system having a graphical user interface including a display and a user interface selection device, a method for displaying a top-level container comprising selectable objects on a navigation tree, the method comprising:
defining the top-level container based upon a category of selectable objects on the navigation tree it contains, said objects being associated with a plurality of products or functions; and
displaying the selectable objects.

2. The method of claim 1, wherein the selectable objects are displayed in a multiple pane navigation display.

3. The method of claim 2, wherein the multiple pane navigation display comprises a top-level pane, a first detail-level pane, and a second detail-level pane.

4. The method of claim 1, wherein the products or functions are located on a plurality of navigation trees associated with a plurality of servers.

5. The method of claim 1, further comprising a plurality of top-level containers of fixed product-independent categories.

6. The method of claim 5, wherein the categories are selected from the group consisting of users, recipients, server configuration, servers, tools, global configuration, and organization configuration.

7. The method of claim 6, wherein the user or recipients top-level container comprises objects on the navigation tree that are associated with users of a plurality of products on a network.

8. The method of claim 6, wherein the server configuration or servers top-level container comprises objects on the navigation tree that are associated with servers having a plurality of functions.

9. The method of claim 6, wherein the toolbox top-level container comprises objects on the navigation tree that are associated with system tools for a plurality of products on a network.

10. The method of claim 6, wherein the global configuration or organization configuration container comprises objects on the navigation tree that are associated with configuration actions utilized to globally configure items on a network.

11. The method of claim 1, wherein one or more computer-readable media have computer-executable instructions for performing the computer-executable method of claim 1.

12. A computer-readable medium having stored thereon a data structure comprising:
a first field of data representing a container on a navigation tree; and
a second field of data representing a plurality of objects on the navigation tree of a related category or action contained in the first field of data;
said objects being located on a plurality of different hierarchical trees.

13. The computer-readable medium of claim 12, wherein the second field of data comprises data on the navigation tree located on a plurality of product hierarchical trees.

14. The computer-readable medium of claim 12, wherein the plurality of hierarchical trees represent product or function information for products or functions that are executing on one or more servers.

15. The computer-readable medium of claim 12, wherein the second field of data comprises objects on the navigation tree associated with users, recipients, server configuration, servers, system tools, global configuration, or organization configuration of a network.

16. The computer-readable medium of claim 12, wherein the second field of data comprises objects on the navigation tree associated with users of a plurality of products on a network.

17. The computer-readable medium of claim 12, wherein the second field of data comprises objects on the navigation tree associated with servers having a plurality of functions.

18. The computer-readable medium of claim 12, wherein the second field of data comprises objects on the navigation tree associated with system tools for a plurality of products on a network.

19. A computer-readable medium having computer-executable instructions for performing a method comprising:
providing a navigational tree comprising a top-level container; and
providing a plurality of objects on the navigation tree of a related category or action contained in the top-level container, wherein the objects are located on a plurality of hierarchical trees.

20. The computer-readable medium of claim 19, wherein the objects on the navigation tree are associated with users, recipients, server configuration, servers, tools, global configuration, or organization configuration of a network.
